(19) United States
(12) Patent Application Publication
(10) Pub. No.: US 2004/0104513 A1
(43) Pub. Date: Jun. 3, 2004

(54) Paper package with injection-molded plastic seams and handle

(76) Inventors: Paul Allen Canino, Milford, OH (US); Karl Whitney Davenport, Loveland, OH (US); Roderick W. Kalberer, Cincinnati, OH (US)

Correspondence Address: HOFFMAN, WASSON & GITLER, P.C., Suite 522, 2361 Jefferson Davis Highway, Arlington, VA, 22202, US

(21) Appl. No.: 10/721,887

(22) Filed: Nov. 26, 2003

Related U.S. Application Data
(62) Division of application No. 10/187,980, filed on Jul. 3, 2002.
(60) Provisional application No. 60/302,380, filed on Jul. 3, 2001.

(51) Int. Cl. B06B 1/02; B29C 45/14

(52) U.S. Cl. 264/442; 264/259; 264/279; 264/250; 156/73.1

(57) ABSTRACT

A coated paperboard blank is placed in the mold and formed into the desired shape of the container. Polymers injection-molded into specific areas about the carton blank to hold the blank together and prevent liquid leaks. Polymer is also injection-molded to form a handle providing easy carrying and pouring. A pouring opening can be injection-molded onto the container top. The bottom of the package has an injection-molded lip to receive a container bottom at a later time.

This application is a divisional of Ser. No. 10/187,980 and claims the benefit of provisional application 60/302,380, filed on Jul. 3, 2001.

### BACKGROUND OF THE INVENTION

Paperboard containers come in all sizes and compete with other materials used to make containers of similar size. In the single serving size, paperboard containers are made in the small gable-top containers most commonly containing milk and aseptic containers having non-carbonated beverages. These containers compete with single-serving plastic bottles and aluminum cans. In larger sizes, paperboard is used to make gable-top cartons in sizes up to a half gallon. These paperboard containers compete with blow-molded plastic bottles.

Paperboard containers in the various sizes have shortcomings when compared to plastic containers. The single-serving containers have a rectangular or square cross-section and do not fit neatly into automobile cup holders. Also, gable-top containers and aseptic juice packages can be difficult to open and the aseptic containers require the use of a straw. The larger paperboard containers have a square rectangular cross-section making grasping and pouring with a single hand difficult. Also, the difficulty in securely grasping a larger paperboard container hinders the ability to carry the container with a single hand.

It is an object of the invention to provide a container made of paperboard and having injection-molded plastic seams.

It is another object of the invention to provide a blank formed into a single-serving size container having a round cross-section.

It is another object of the invention to provide a container having a pour spout allowing for the easy dispensing of the contents.

It is yet another object of the invention to provide an injection molded plastic handle with the paperboard container.

These and other objects of the invention will become apparent to one of ordinary skill in the art after reading the disclosure of the invention.

### SUMMARY OF THE INVENTION

A coated paperboard blank is placed in the mold and formed into the desired shape of the container. Polymer is injection-molded into specific areas about the carton blank to hold the blank together and prevent liquid leaks. Polymer is also injection-molded to form a handle providing easy carrying and pouring. A pouring opening can be injection-molded onto the container top. The bottom of the package has an injection-molded lip to receive a container bottom at a later time.

The containers can be single serve size or containers holding larger sizes, such as quart, half gallon, three quart and gallon. The round cross section of the single serve size allows the package to be substituted for aluminum cans and plastic bottles. The large size is easy to open and the handle allows for easy pouring. The print quality of the paperboard material obviates the need for labels.

### BRIEF DESCRIPTION OF THE DRAWINGS

FIG. 1 is a perspective view of a paperboard container with injection molded seams;

FIG. 2 is a plan view of a blank used to make the container of the invention;

FIG. 2a is a view of the alternative blanks to make the container of FIG. 1;

FIG. 3 is an alternative blank for making the container of FIG. 1 with a distinct top rim;

FIG. 4 is a cross sectional view of the container of FIG. 1;

FIG. 5 is a side view of a container with injection molded handle and closure;

FIG. 6 is an end view of the container shown in FIG. 5;

FIG. 7 is a top view of the container of FIG. 5;

FIG. 8 is a plan view of a blank used to make the container of FIG. 5;

FIG. 9 is a view of a container with an alternative embodiment of the injection molded handle; and

FIGS. 10a-10e are cross sections of various shapes of the injection molded handle.

### DETAILED DESCRIPTION OF THE INVENTION

A paperboard carton blank is coated on the exterior with low density polyethylene and on the interior with either low density polyethylene for dairy applications or co-extruded barrier materials for juice and juice drink applications. Typical co-extruded barrier materials are nylon for pin-hole resistance and an oxygen barrier, EVOH, for oxygen and flavor barrier, low-density polyethylene (LDPE) for sealing and caulking and tie layers to adhere the LDPE to the nylon and EVOH. An example of a typical laminate is disclosed in U.S. Pat. No. 6,110,548. Alternatively, the blank could be coated with polypropylene on the gloss side and with polypropylene on the inside or with polypropylene as the product contact layer in a multi-layer co-extrusion on the inside. The carton blank is typically printed and has an overprint varnish applied prior to being formed into a beverage package.

The carton blank is inserted into an injection-molding press and mold. The flat carton blank is folded and curled into the desired shape by the mold, and injection molding takes place. Polymer is injection-molded into specified areas around the carton blank to form the blank into a carton by sealing the seams. Typical polymers which can be used during the injection-molding process are low-density polyethylene, high-density polyethylene, polypropylene, nylon or PET. The choice of polymer is selected to match the coating on the paperboard to provide good adhesion. For the cavity in the injection mold, a split tool can be used that will open to allow package features to be stripped out.

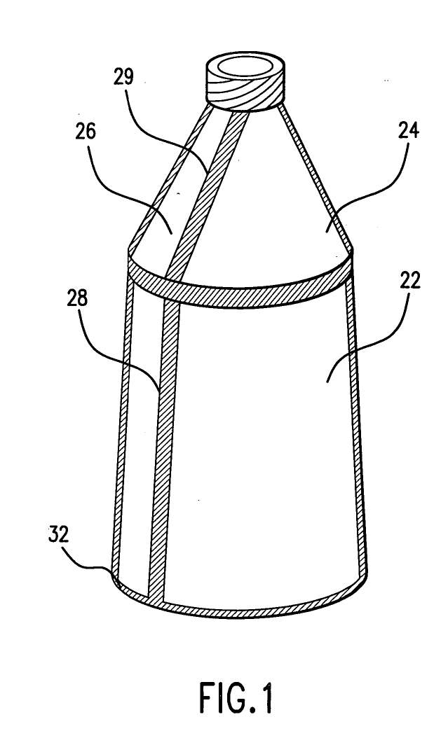

A typical bottle formed by the process is shown in FIG. 1. The depicted bottle is made of two blanks 22, 24 with a first blank 22 forming the bottom of the container and the second blank 24 forming the upper part of the container. A circumferential injection molded seam 26 joins the first and second blank. Each blank has a vertically extending seam 28, 29 forming the flat blank into the closed container. More vertical seams could be injection molded depending on the number of blanks used to form the container, and to add additional strength or stability. An injection molding ring 32 encircles the bottom of the container 10 to seal a bottom at a later time. The container can be made from a one piece blank if the top section has the appropriate cut outs.

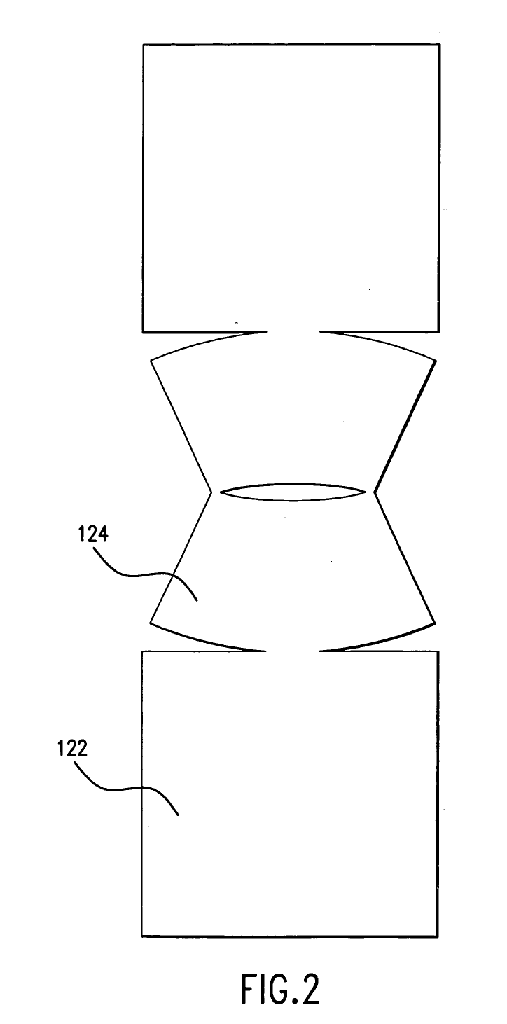

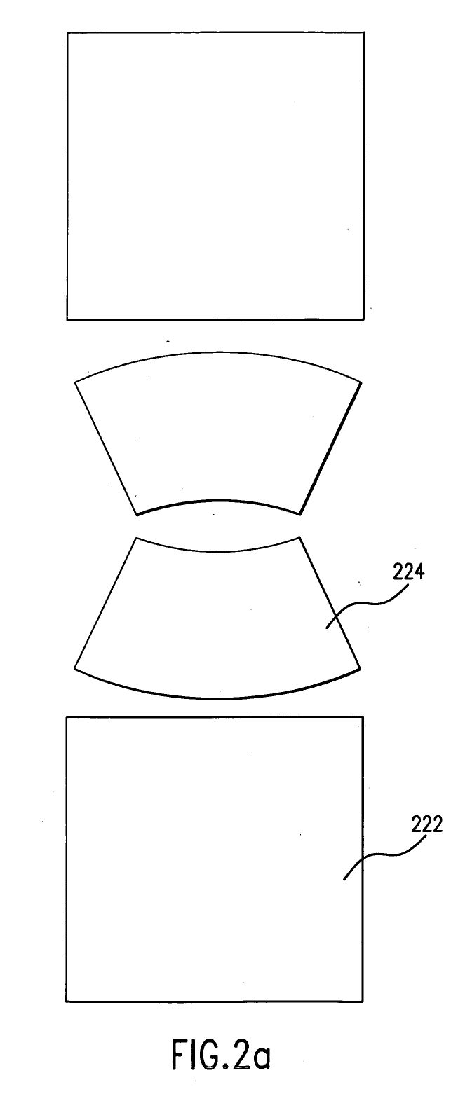

FIG. 2 shows a blank used to make the container of the invention. The blank has four panels connected serially. The two central panels 124 form the neck of the container. The two distal panels 122 form the base of the container. When the blank is formed into the container, the side edges of the panel is brought together and plastic is injection-molded into the seams to complete the container. As shown in FIG. 2a, the four panels can be formed as separate blanks 222, 224. Also, the blanks making the neck and base can be joined to one another along their side edges resulting in a single blank for making the base and a single blank for making the neck.

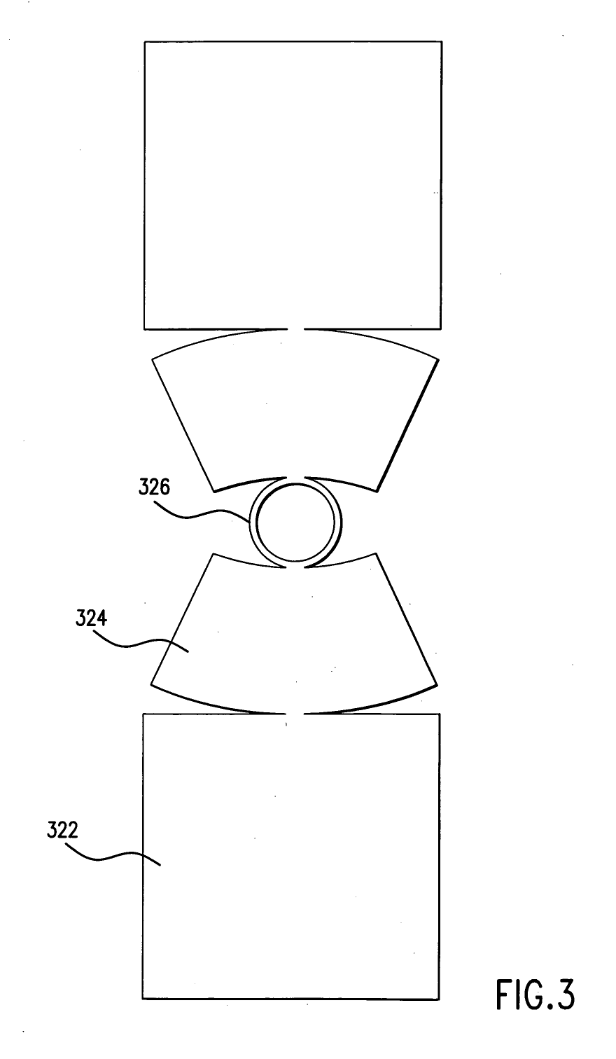

An alternative blank for making the container of FIG. 1 is shown in FIG. 3. The blank has a series of panels serially connected together, similar to the blank of FIG. 2. A top rim panel 326 is connected between the panels 324 forming the neck of the container. The taper angle of the bottle can be varied to any desired angle.

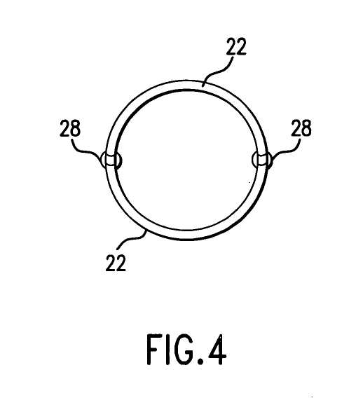

FIG. 4 shows a cross sectional view of the bottle made in accordance with the invention. As can be seen in the cross sectional view, the injection molded seam forms a bead of plastic on the inner surface of the bottle. This is a result of plastic being injection molded into a seam. The cross sectional shape of the depicted bottle is circular, however, containers can be made with a variety of cross sectional shapes including oval, elliptical or rectangular with rounded corners.

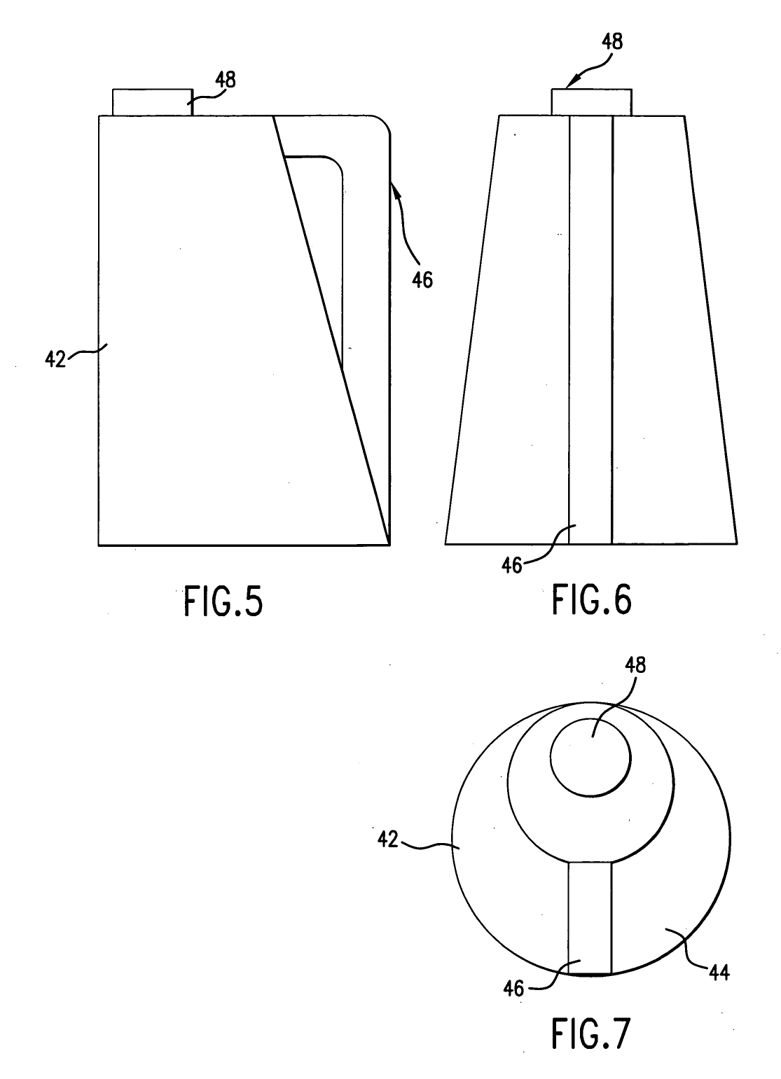

Polymer can be injection-molded to form a handle 46. A side view of such a container is shown in FIG. 5. The end view is shown in FIG. 6 and top view is shown in FIG. 7. The handle cross-section can be an I-beam to provide strength and ease of manufacturing. The polymer can also be used to form a pouring opening 48 on the package with threads to receive a cap, or without threads for a snap cap or pull tape or film. The pouring opening can also have a plug with an attached pull-ring removed by the customer to open the package, to prevent leaks and provide tamper-resistance. Instead of a pull-ring, the package can have a foil material that must be removed before consumption. The cap may have a tamper-evident break band, if external tamper evidence is desired. Another possible form of external tamper evidence is a film over the cap that must be broken in order to remove the cap.

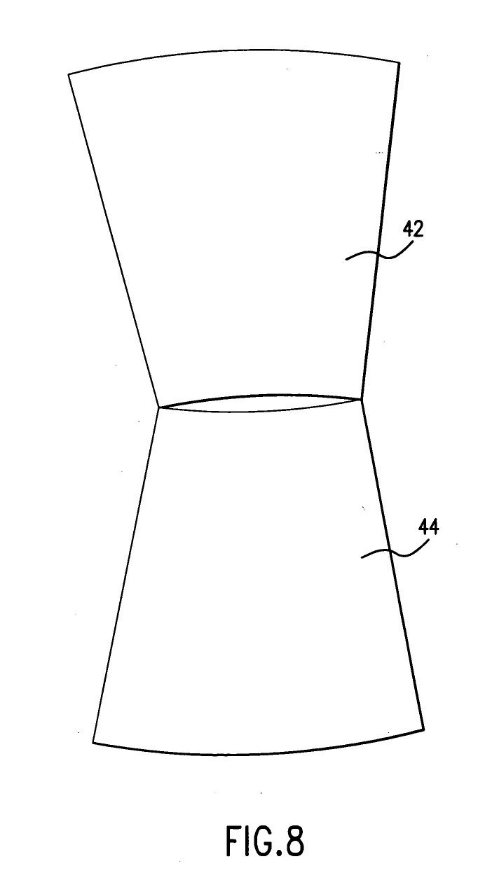

FIG. 8 depicts a blank used to make the container of FIG. 5. The blank has two panels 42, 44 connected to one another at their top corners. The side edges of the two panels are brought together in a mold and plastic is injection molded into the seam formed between the side edges. In this manner, a container sidewall having two seams is created. Similar to the bottom shown in FIG. 1, a bottom wall is welded to the bottom edge of the side wall and a top wall is attached to the top edge of the side wall.

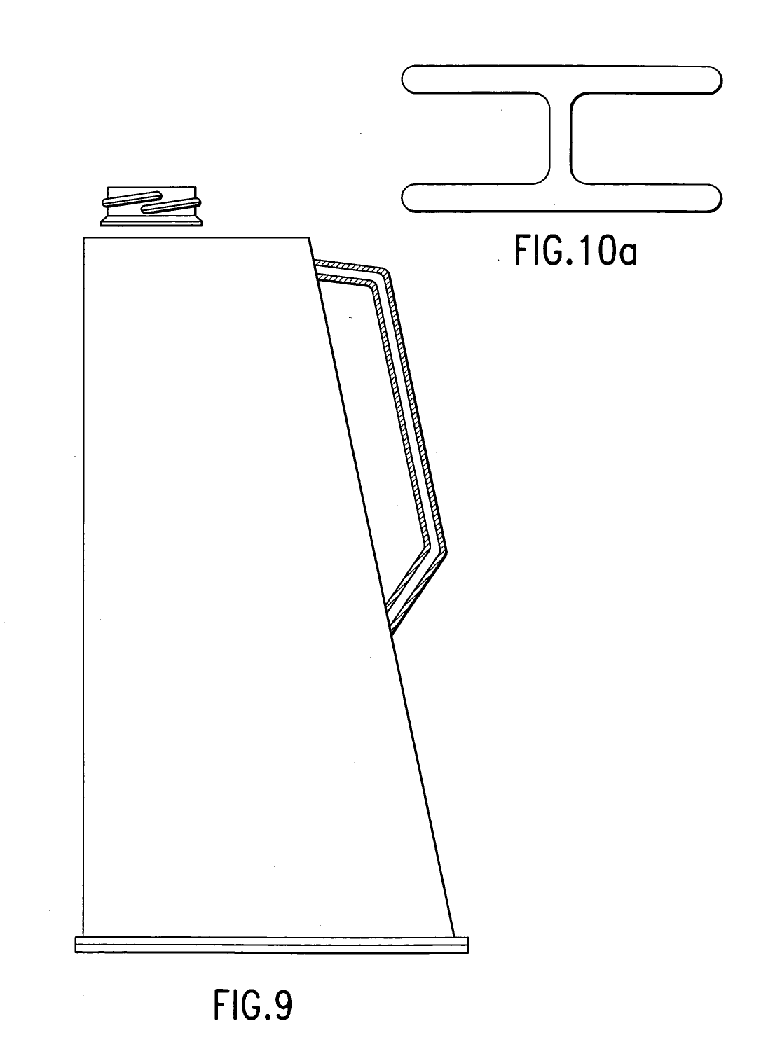

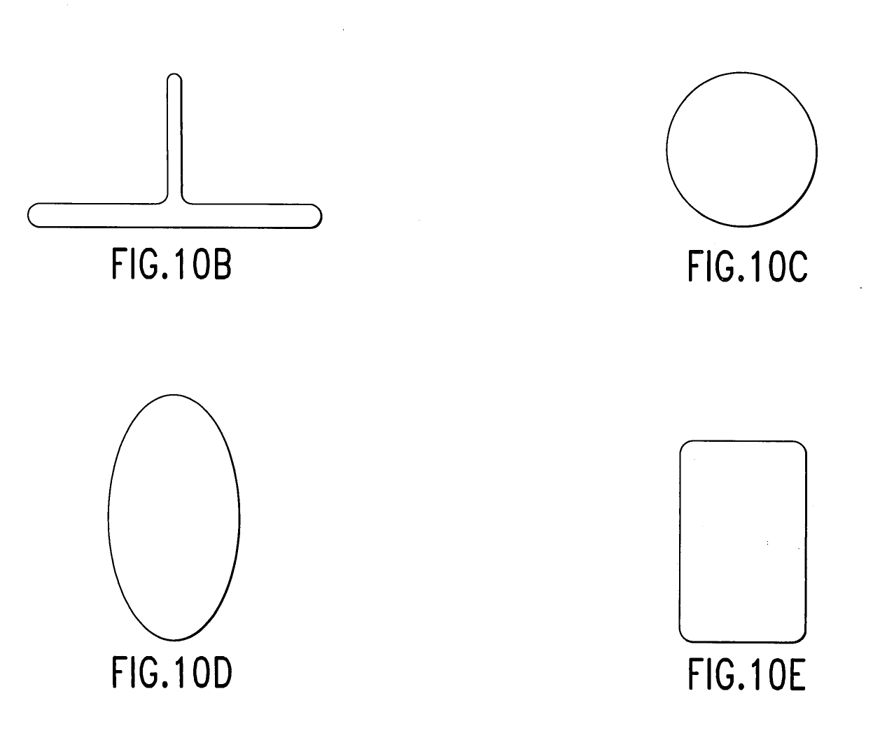

FIG. 9 shows a container having an alternative embodiment of the handle. In this embodiment, the handle does not extend to the bottom of the side wall, but attaches to the side wall at a location spaced above the bottom wall. FIG. 10a is a cross sectional view of the handle showing the I-shaped cross section. FIG. 10b shows an alternative cross section of the handle. This cross section is T-shaped with the base of the T creating the inner surface of the handle, facing the side wall. Alternatively, the base of the T could be used to create the outer surface of the handle FIGS. 10c, 10d and 10e show various cross sections of handles. These handles have a cross section that is round, oval or rectangular, respectively. Each of these handles is fluted to allow for injection molding and to reduce the amount of material required.

The injection-molding can be done with clear polymers so that the user can see between the paper seams and see the contents of the package or with pigmented polymers if a specific color is desired. An injection-molded lip is formed at the bottom of the package so that the package bottom can be sealed to the package at a later time. The open bottom is needed to allow the tooling to be pulled from the package following forming and injection molding. The bottom that is later attached can be injection-molded plastic, extrusion-coated paperboard, or thermoformed plastic. The bottom is sealed to the package using ultrasonics, hot air or conduction heat. The bottom can be sealed to the package by spin welding as well.

Filling of the package can take place through the dispensing spout if a pull-ring is not in the way, or filled through the bottom before the bottom is applied. The package can be filled on a conventional bottle filler or cup-filling equipment. Following filling, the final closure on the top or bottom of the package is completed to seal the package.

The process is used to produce a beverage package simulating a bottle but using paper. A single-paper blank can be used to produce a conical-shaped package with a constant draft angle. Multiple blanks or perforated blanks can be used to produce a package having a change in draft angle at a specified point. Some draft angle may be required in all sections to allow the package to be removed from the machine tooling, although it would be possible to remove a package with zero or near-zero draft angle. The package may also have a round cross-section with the diameter changing with height. Typically, the package will have two opposing side-seams, although it is possible to have one side-seam, or more than two. It is also possible to produce a package having an elliptical cross-section, oval cross-section, or rectangular cross-section having rounded corners. The package can be made in sizes up to one and one-half gallons.

What is claimed is:

1. A method of making a container, comprising
forming a blank
placing said blank into a mold to form a side wall of a container, said sidewall having a lower portion and a upper portion, said upper portion having a dispensing opening, said side wall having at least one seam between said upper portion and said lower portion,
injecting plastic into said mold to seal said at least one seam.

2. The method of claim 1, further comprising
injection molding a dispensing opening on said container having threads for receiving a closure.

3. The method of claim 1, further comprising injection molding a handle to said container.

4. The method of claim 3, wherein
said handle has one of an I-shaped, T-shaped, round, oval or rectangular cross section.

5. The method of claim 1, further comprising sealing a bottom to said side wall.

6. The method of claim 5, further comprising sealing said bottom to said container by ultrasonic, hot air or conduction heat.

7. A method of making a container, comprising
forming a blank
placing said blank into a mold to form a side wall of a container,
injecting plastic into said mold to form a handle attached to said side wall, said handle having a first portion extending outwardly from said sidewall and a second portion spaced from said side wall.

8. The method of claim 7, further comprising
forming said handle with an I-shaped, T-shaped, round, oval or rectangular cross section.
